(19) United States
(12) Patent Application Publication
(10) Pub. No.: US 2023/0214102 A1
(43) Pub. Date: Jul. 6, 2023

(54) User Interface With Interactive Multimedia Chain

(71) Applicant: Shimmeo, LLC, Little Ferry, NJ (US)

(72) Inventor: Hubert Pietrzykowski, Warsaw (PL)

(73) Assignee: Shimmeo, LLC, Little Ferry, NJ (US)

(21) Appl. No.: 17/569,122

(22) Filed: Jan. 5, 2022

(51) Int. Cl. G06F 3/04845; G06F 3/0488

(52) U.S. Cl. CPC G06F 3/04845; G06F 3/0488; G06F 3/04842

(57) ABSTRACT

The technology described herein is directed to a user interface for displaying multimedia data, such as videos, images, and audio. The technology includes a system, including a processor and storage device in communication with a processor. The storage device may store instructions that cause the processors to display a set of multimedia data within media locations of an interface. The media locations are positioned across three rows within the interface including a top row, bottom row, and center row. A respective piece of the set of multimedia data may be positioned at each media location. The multimedia data may be and moved through from one media location to another within the interface.

### BACKGROUND

Portable user devices, such as smartphones, typically have a limited amount of display real estate. As such, displaying data to a user intuitively and informatively may be difficult. Further, given the diminutive size of displays in portable devices, it may be difficult to navigate through the displayed data.

### BRIEF SUMMARY

Aspects of the disclosure are directed to an interactive interface. One aspect of the disclosure is directed to a system for providing an interactive interface. The system may comprise one or more processors; and one or more storage devices in communication with the one or more processors. The one or more storage devices contain instructions configured to cause the one or more processors to: display a set of multimedia data within media locations of an interface, wherein the media locations are positioned across three rows within the interface including a top row, bottom row, and center row and a respective piece of the set of multimedia data is positioned at each media location; move, in response to user input requests: the respective pieces of multimedia data from right to left across the media locations on the bottom row and top row, from a left-most media location in the bottom row to a single media location in the center row, and from the single media location in the center row to a right-most media location in the top row; and provide one or more data selectors configured to change the displayed set of multimedia data within the interface.

In some instances, the multimedia data includes one or more of videos, audio, or images.

In some instances, the instructions are further configured to cause the one or more processors to change the displayed set of multimedia data with a new set of multimedia data upon receiving a selection of the one or more data selectors.

In some instances, the instructions are further configured to cause the one or more processors to display multimedia information in the single media location in the center row upon receiving a second user input request.

In some examples, the multimedia information corresponds to the multimedia data at the single media location in the center row.

In some examples, the second user input request is a sideswipe on a touch-screen of the system.

In some instances, the user input requests are upward swipes on a touch-screen of the system.

Another embodiment is directed to a non-transitory computer-readable medium storing instructions. The instructions, when executed by one or more processors, cause the one or more processors to: display a set of multimedia data within media locations of an interface, wherein the media locations are positioned across three rows within the interface including a top row, bottom row, and center row and a respective piece of the set of multimedia data is positioned at each media location; move, in response to user input requests: the respective pieces of multimedia data from right to left across the media locations on the bottom row and top row, from a left-most media location in the bottom row to a single media location in the center row, and from the single media location in the center row to a right-most media location in the top row; and provide one or more data selectors configured to change the displayed set of multimedia data within the interface.

In some instances, the multimedia data includes one or more of videos, audio, or images.

In some instances, the instructions are further configured to cause the one or more processors to change the displayed set of multimedia data with a new set of multimedia data upon receiving a selection of the one or more data selectors.

In some instances, the instructions are further configured to cause the one or more processors to display multimedia information in the single media location in the center row upon receiving a second user input request.

In some examples, the multimedia information corresponds to the multimedia data at the single media location in the center row.

Another aspect of the technology is directed to a method for interacting with an interface for viewing multimedia data. The method comprising: displaying, by the one or more computing devices, a subset of multimedia data, selected from a set of multimedia data, at media locations within the interface, each piece of multimedia data within the subset of multimedia data being displayed at a respective media location, wherein the media locations are arranged in three rows including a top row, bottom row, and center row; receiving, by the one or more computing devices, a user input requesting the subset of multimedia data be advanced within the interface; moving, in response to the user input and by the one or more computing devices, the subset of multimedia data, said moving including: moving a first piece of the subset of multimedia data from a media location in the top row off of the interface, and moving a second piece of the subset of multimedia data from off of the interface into a media location in the bottom row of the interface; and in response to a second user input, displaying, multimedia information associated with a third piece of the subset of the multimedia data at a media location in the center row.

In some instances, the top row includes four media locations, the bottom row includes four media locations, and the center row includes a single media location.

In some examples, moving the first piece of the subset of multimedia data from the media location in the top row off of the interface, includes moving the first piece of the subset of multimedia data from a leftmost media location in the top row of the interface.

In some examples, moving the second piece of the subset of multimedia data from off of the interface into the media location in the bottom row of the interface includes moving the second piece of the subset of multimedia data into a rightmost media location in the bottom row of the interface.

In some instances, the moving further includes moving the third piece of the subset of multimedia data from a leftmost media location in the bottom row to the single media location in the center row.

In some examples, the method further includes receiving a third user input requesting the subset of multimedia data be advanced within the interface; and moving, in response to the user input, the third piece of the subset of multimedia data from the single media location in the center row to a rightmost media location in the top row.

In some examples, the multimedia data includes one or more of videos, audio, or images.

In some instances, the method further includes receiving a third user input requesting a new subset of multimedia data selected from the set of multimedia data; and replacing the displayed subset of multimedia data with a second subset of multimedia data within the interface.

### BRIEF DESCRIPTION OF THE DRAWINGS

The aspects, features, and advantages of the present invention described herein will be further appreciated when considered with reference to the following description of exemplary embodiments and accompanying drawings, wherein like reference numerals represent like elements. In describing the embodiments of the invention illustrated in the drawings, specific terminology may be used for the sake of clarity. However, the aspects of the invention are not intended to be limited to the specific terms used.

FIG. 1 is a functional diagram of an example system in accordance with aspects of the disclosure.

FIG. 2 is a pictorial diagram of the example system of FIG. 1.

FIG. 3 illustrates an interface for viewing multimedia data in accordance with aspects of the disclosure.

FIG. 4 illustrates an initial position of multimedia data within an interface in accordance with aspects of the disclosure.

FIGS. 5A-5F illustrate the movement of multimedia data within media locations of an interface in accordance with aspects of the disclosure.

FIG. 6 illustrates another movement of multimedia data within media locations of an interface in accordance with aspects of the disclosure.

FIGS. 7A and 7B illustrate alternating between multimedia data and multimedia information in the interface, in accordance with aspects of the disclosure.

FIGS. 8A and 8B illustrate switching data sets within the interface, in accordance with aspects of the disclosure.

### DETAILED DESCRIPTION

This technology relates to an interface for navigating multimedia data. The interface may display the multimedia data at predefined locations across a number of rows. When a user navigates through the multimedia data, the interface may cause the multimedia data to move in a predefined pattern, such as a snaking pattern described further herein. In this regard, the multimedia data may be arranged in the form of a “multimedia chain.” A multimedia chain includes a set of multimedia data, such as images, that are connected together such that the multimedia data maintains a consistent configuration as it moves through the interface.

The interface may provide the ability to view additional information associated with the multimedia data through a user input. The additional information may include information about the multimedia data. Additionally, the interface may provide the ability to change the multimedia data being displayed.

### Example Systems

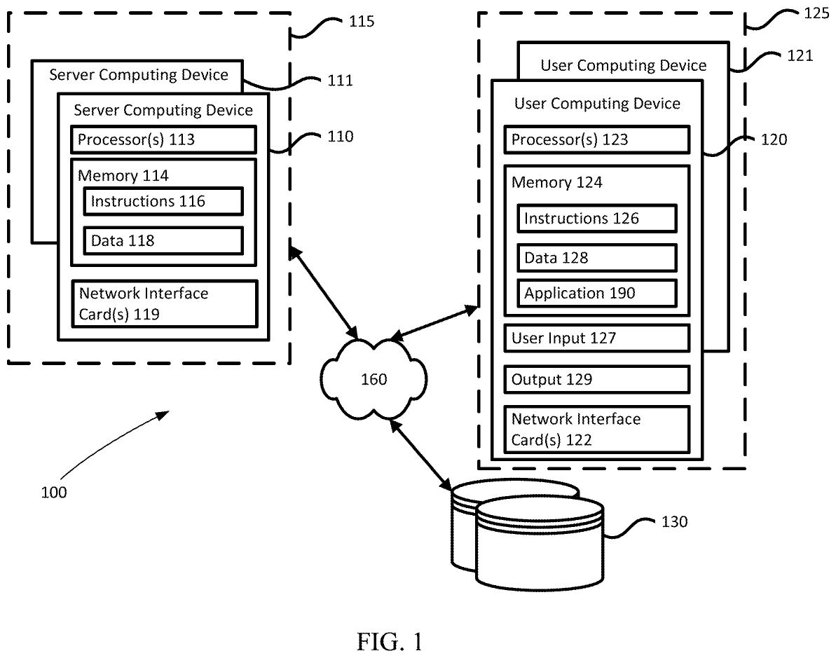

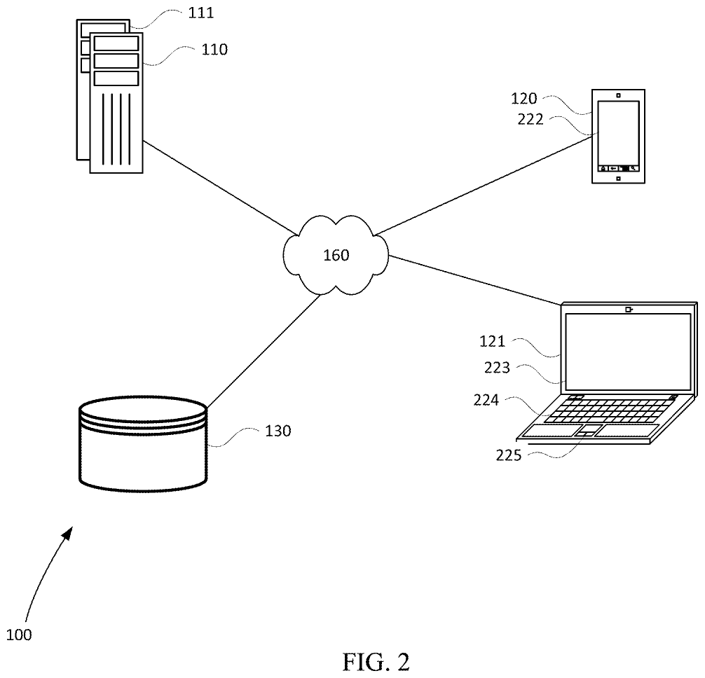

FIGS. 1 and 2 include an example system 100 in which the features described herein may be implemented. It should not be considered as limiting the scope of the disclosure or usefulness of the features described herein. In this example, system 100 can include server computing devices 115, including server computing devices 110, 111, user computing devices 125, including user computing devices 120, 121, as well as storage system 130. Although only two server computing devices and two user computing devices are shown in FIGS. 1 and 2, it should be appreciated that any number of connected computing devices including server computing devices, client computing devices, and storage systems may be included in the system 100 at different nodes of the network 160. Each of the computing devices 110, 111, 120, and 121 can contain one or more processors, memory, network interfaces, and other components typically present in general-purpose computing devices.

Server computing device 110 includes processor 113, memory 114, and network interface card 119. The other server computing device 111, as well as any other server computing devices, may include some or all of the components shown in server computing device 110, or user computing device 120, described herein.

Memory 114 of server computing device 110 can store information accessible by the one or more processors 113, including instructions 116 that can be executed by the one or more processors 113. Memory can also include data 118 that can be retrieved, manipulated, or stored by the processor. Memory can also store applications, including user interfaces, as described herein. The memory 114 may be any type of non-transitory computer readable medium capable of storing information accessible by the processor 113, such as a hard-drive, solid-state drive, NAND memory, tape drive, optical storage, memory card, ROM, RAM, DVD, CD-ROM, write-capable, and read-only memories

The instructions 116 can be any set of instructions to be executed directly, such as machine code, or indirectly, such as scripts, by the one or more processors. In that regard, the terms “instructions,” “steps,” and “programs” can be used interchangeably herein. The instructions 116 can be stored in object code format for direct processing by the processor 113, or in any other computing device language including scripts or collections of independent source code modules that are interpreted on demand or compiled in advance.

Data 118 may be retrieved, stored or modified by the one or more processors 113 in accordance with the instructions 116. For instance, although the system and methods described herein is not limited by any particular data structure, the data 118 can be stored in hierarchical file systems, computer registers, in a relational database as a table having many different fields and records, or XML documents. The data 118 can also be formatted in any computing device-readable format such as, but not limited to, binary values, ASCII or Unicode, etc. Moreover, the data 118 can include any information sufficient to identify the relevant information, such as numbers, descriptive text, proprietary codes, pointers, references to data stored in other memories, such as at other network locations, or information that is used by a function to calculate the relevant data. Example data 118 may include multimedia data such as image files (e.g., jpeg, png, gif, raw, etc.) and/or audio files, video files, or combinations of audio, video, and/or image files.

Data 118 may also include information related to the multimedia data. For example, the data 118 may include information describing the contents of an image file or other such multimedia data. For instance, an image or video may include imagery of a celebrity and the information describing the contents of the information (“multimedia information”) may include biographical information of the celebrity. In another example, an image may include imagery of a location, and the multimedia information corresponding to the image may include information about the location, such as GPS coordinates, historical information of the location, description information of the location, etc. In another example, the multimedia data may include audio files and multimedia information may include the title of the audio file, artist that performed/recorded the audio, track number, album name, length of the track, etc. It is to be understood that the aforementioned examples of multimedia data and multimedia information are merely for illustration purposes and that such examples should not be considered limiting.

The multimedia data may be separated into of one or more sets of multimedia data. The sets of multimedia data may be generated manually or automatically. For example, a collection of images may be separated into sets of images, with each set of images having a shared characteristic. For instance, sets of images may include all images captured on a particular day (e.g., set one includes images captured on the July 4^{th}, set two includes images captured on Christmas, set three includes images captured on New Years, etc.) In another example, a collection of images may be separated into individual sets of images that include individuals with the same birthday or other shared information between the individuals, such as indicated in the biographical information associated with the images.

In some examples, each set may include different types of multimedia data. For example, a set of multimedia data may include any combination of images, videos, audio, etc., and, in some instances, the multimedia information associated with such multimedia data.

The one or more processors 113 of server computing device 110 can be any conventional processor, such as a commercially available central processing unit (CPU). In some instances, the processors 113 of server computing device 110 may be specially programed processers, such as ASIC-based processors. Although not necessary, server computing device 110 may include specialized hardware components to perform specific computing processes, such as decoding/encoding video, audio and/or video processing, image processing, etc.

The network interface 117 can be any device capable of enabling a computing device to communicate with another computing device or networked system. For instance, the network interface 117 may include a network interface card (NIC), Wi-Fi card, Bluetooth receiver/transmitter, or other such devices capable of communicating data over a network via one or more communication protocols, such as point-to-point communication (e.g., direct communication between two devices), Ethernet, Wi-Fi, HTTP, Bluetooth, LTE, 3G, 4G, Edge, etc., and various combinations of the foregoing.

The processor 113, memory 114, and other elements can be multiple processors, computers, computing devices, or memories that may or may not be stored within the same physical housing. For example, the memory can be a hard drive or other storage media located in one or more housings different from that of server computing device 110 illustrated in FIG. 2. Accordingly, references to a processor, computer, computing device, or memory, when used in reference to any of the computing devices will be understood to include references to a collection of processors, computers, computing devices, or memories that may or may not operate in parallel. Yet further, although some functions described below are indicated as taking place on a single computing device with one or more processors of the computing device, various aspects of the subject matter described herein can be implemented by a plurality of computing devices, for example, communicating information over network 160.

User computing devices 125 may be a personal computing device intended for use by a user, such as a laptop, full-sized computer, smartphone, etc. For example, and as illustrated in FIG. 2, user computing device 120 is illustrated as a smartphone and user computing device 121 is illustrated as a laptop computer. However, user computing devices 125 may be a full-sized personal computing device or mobile computing devices capable of wirelessly exchanging data with a server over a network, such as network 160. By way of example only, user computing devices may be a mobile phone or a device such as a wireless-enabled PDA, a tablet PC, a netbook, notebook, a smartwatch, a head-mounted computing system, or any other device that is capable of obtaining information via a network.

User computing devices 125 may include all components normally used in connection with a personal computing device. For example, user computing device 120 includes processor 123, memory 124 storing instructions 126 (e.g., applications,) and data 128 (e.g., multimedia data and related information,) and a network interface 122, which may be compared to processor 113, memory 114 (including instructions 116 and data 118,) and network interface card 119, respectively.

User computing devices may also include other components normally used in connection with a personal computing device, such as user inputs and outputs. Example outputs may include displays (e.g., a monitor having a screen, a touch-screen, a projector, a television, or another device that is operable to display information), speakers, or data connectors (e.g., USB ports, etc.,) or other such components capable of outputting data.

Example input devices may include a mouse, keyboard, touch-screen, camera for recording video and/or individual images, microphone for capturing audio, or other such devices. During operation, a user may input information using a small keyboard, a keypad, a microphone, using visual signals with a camera, or a touch screen. In another example, a user may input audio using a microphone and images using a camera, such as a webcam.

As illustrated in FIG. 2, user computing device 120 includes touch-screen display 222, which functions as both a user input device and user output device. User computing device 121 includes touch-screen display 223, which also functions as a user input and output. User computing device 121 also includes a keyboard 224 and trackpad 225, which function as user inputs. Although not shown, both computing devices 120, 121 also include speakers.

As with memory 114, storage system 130 can be any type of computerized storage capable of storing instructions and/or data accessible by the computing devices 115, 125 such as one or more of a hard-drive, a solid-state hard drive, NAND memory, ROM, RAM, DVD, CD-ROM, write-capable, and read-only memories, or any other device capable of storing data. In addition, storage system 130 may include a distributed storage system where data is stored on a plurality of different storage devices, which may be physically located at the same or different geographic locations. As explained herein, storage system 130 may be connected to the computing devices via the network 160 as shown in FIGS. 1 and 2 and/or may be directly connected to any of the computing devices 115, 125. In this regard, each of the computing devices 115, 125 and storage system 130 can be at different nodes of a network 160 and capable of directly and/or indirectly communicating with other nodes of network 160. For example, multimedia data and/or related information may be stored at storage systems at different nodes of the network 160. The multimedia data and/or related information stored at each location may be the same date or different data.

The network 160 and the computing devices 115, 125 can be connected using various protocols and systems, such that the network can be part of the Internet, World Wide Web, intranets, wide area networks, and local networks. The network can utilize standard communications protocols and systems, such as point-to-point communication (e.g., direct communication between two devices), Ethernet, Wi-Fi, HTTP, Bluetooth, LTE, 3G, 4G, 5G, Edge, etc., as well as protocols and systems that are proprietary to one or more companies, and various combinations of the foregoing. Although certain advantages may be obtained when information is transmitted or received, as noted above, other aspects of the subject matter described herein are not limited to any particular manner of transmission of information.

As an example, server computing device 110 may be capable of communicating with storage system 130 as well as client computing devices 120, 121 via the network 160. For instance, server computing device 110 may use network 160 to retrieve image data from storage system 130 and transmit the image data to a client computing device, such as client computing devices 120 for display on display 222.

As shown in FIG. 2, the client computing device may execute an application 190. In this regard, application 190 may be a mobile app or full application capable of being executed on a full-sized computing device. In other examples, application 190 may be a web-based app provided by server computing device 110. In this regard, the web-based app may be executed within a web browser (not shown) on the client computing device 120. As further described herein, the application 190 may include a user interface for retrieving, displaying, and navigating multimedia data and related multimedia information.

### Example Interface

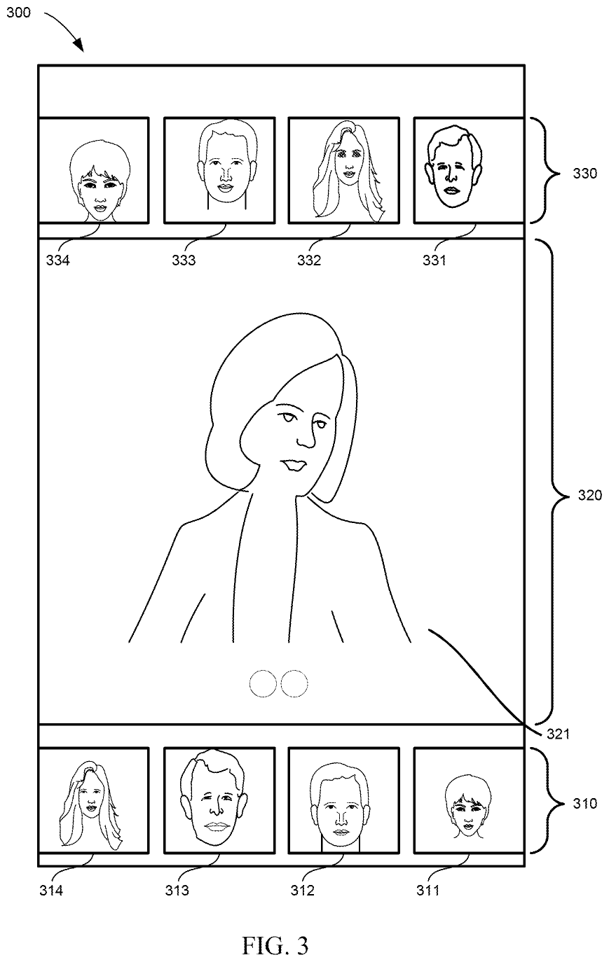

FIG. 3 is an interface 300 for viewing multimedia data within an application executing on a client computing device, such as client computing device 120. The interface 300 may be presented on a display, such as touchscreen display 222 of user computing device 120. As illustrated, interface 300 includes a bottom row 310, a center row 320, and an upper row 330 (collectively, “the rows”). Although only three rows are shown, the interface can include any number of rows.

The interface 300 shown in FIG. 3 illustrates each of the rows containing images at media locations, with bottom row 310 including images at media locations 311-314, center row 320 including an image at media location 321, and top row 330 including images at media locations 331-334. Although FIG. 3 illustrates the top row 330 and bottom row 310 as including four media locations, and the center row 320 as including a single media location, each row may include any number of media locations. Further, while FIG. 3 illustrates the media locations as including images, the media locations may display any type of multimedia data. For example, in instances when a media location includes audio data, the interface may display placeholder images or text for each piece of multimedia data in the media location. For instance, an audio file may be represented by a music note, an image of the artist(s), album art, etc. In instances where the media location includes a video file, the interface may display a screenshot, video clip, or the entire video file may be displayed and/or played in the media location. In some instances, audio and/or video file may play when the audio video file is in a particular location, such as in the center row 320.

The interface 300 shown in FIG. 3 illustrates each media location as being square, but the media locations may be any shape and/or size. For instance, media locations (and, in some instances the media displayed in the media locations) may be rectangular, polygonal, triangular, circular, etc. Further, the media displayed in the media locations may fill some or all of the media locations. Moreover, placeholders for the media locations without multimedia data (e.g., images, text, audio, etc.) may be presented in interface 300, such as empty boxes. Alternatively or additionally, no placeholders for the media locations without multimedia data may be presented in the interface. Further, interface 300 may include partial media locations.

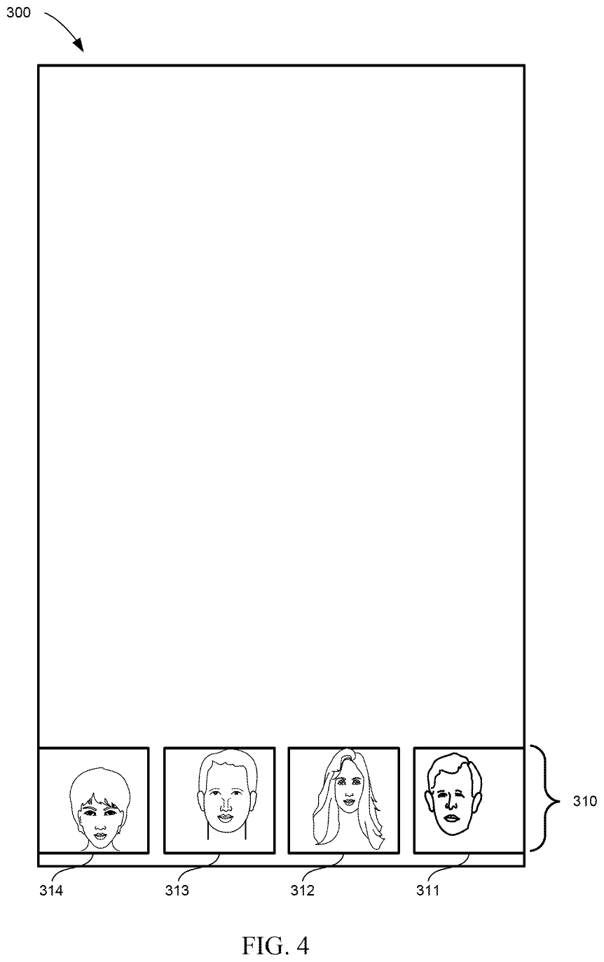

For illustration purposes, the interfaces shown in FIGS. 4-6 and described herein include only image files, but other multimedia data may be used in place of, or in addition to the image files.

FIG. 4 shows the interface 300 at an initial position upon startup or upon selection of a new set of multimedia data. As illustrated, interface 300 displays images at media locations 311-314 of the bottom row 310. The images may belong to a selected set of multimedia data or may belong to a default set of multimedia data assigned to populate media locations 311-314 at the startup of the application. Each of the images in the selected or default set may be retrieved from memory 124 by the application, provided by a server computing device, such as server computing device 110, and/or retrieved from a storage system, such as storage system 130.

Although FIG. 4 shows the images as being at media locations 311-314 of the bottom row 310, in some instances the images may be displayed in any combination of media locations, including any or all of media locations 311-314, 321, and 331-334. Collectively, the images in the media locations form an “image chain.” When multiple types of multimedia data is displayed in the media locations, the collection of multimedia data may be referred to as a “multimedia chain.” Other types of “chains” may include “video chains” i.e., all video multimedia data,) “audio chains” (i.e., all audio multimedia data,) etc. As described herein, multimedia chains may include a lead piece of multimedia data at the start of the multimedia chain and a tailpiece of multimedia data at the end of the multimedia data. There may be any number of intervening pieces of multimedia data between the lead and tailpiece of a multimedia chain.

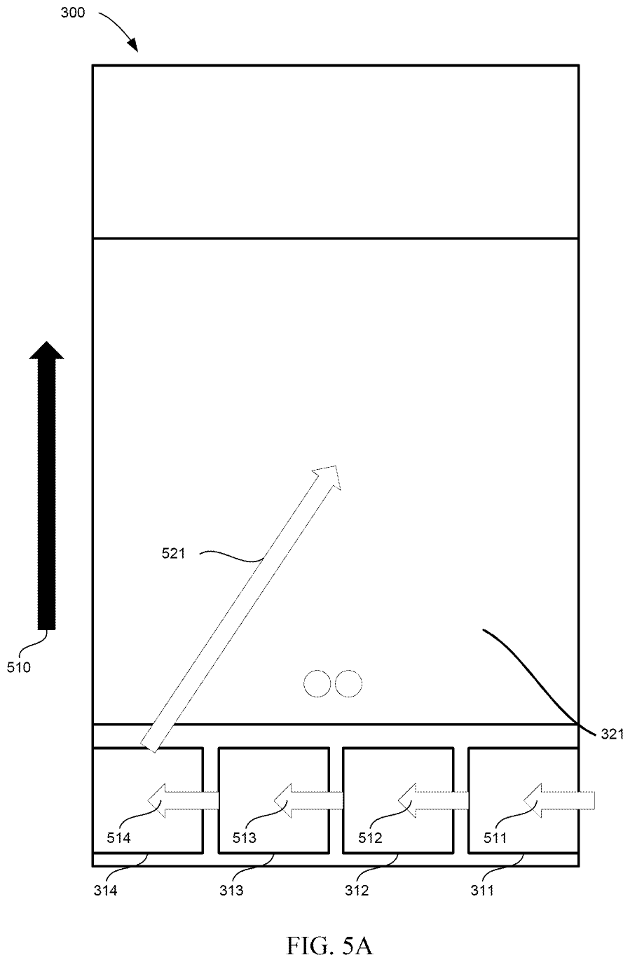

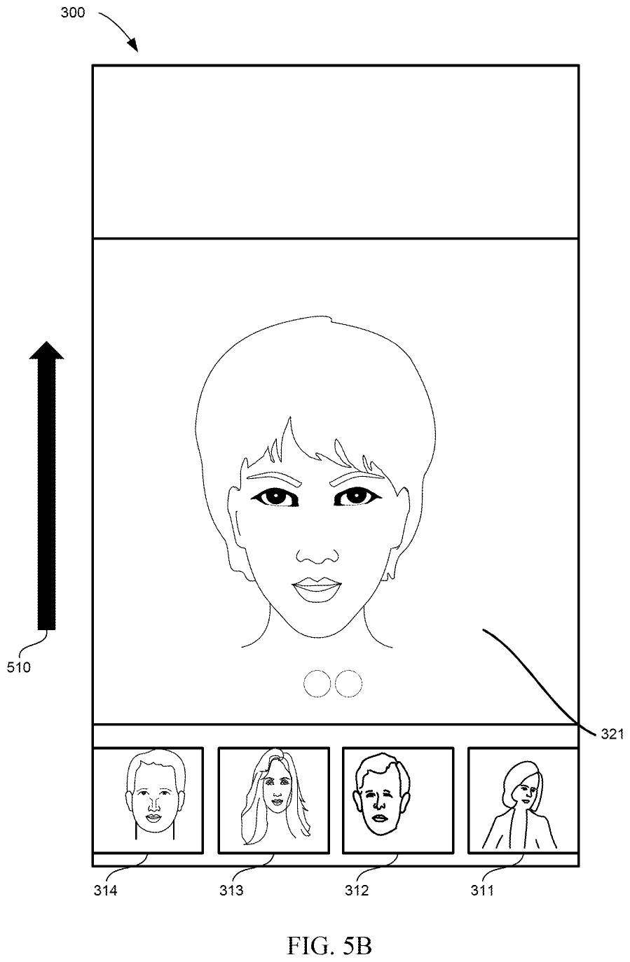

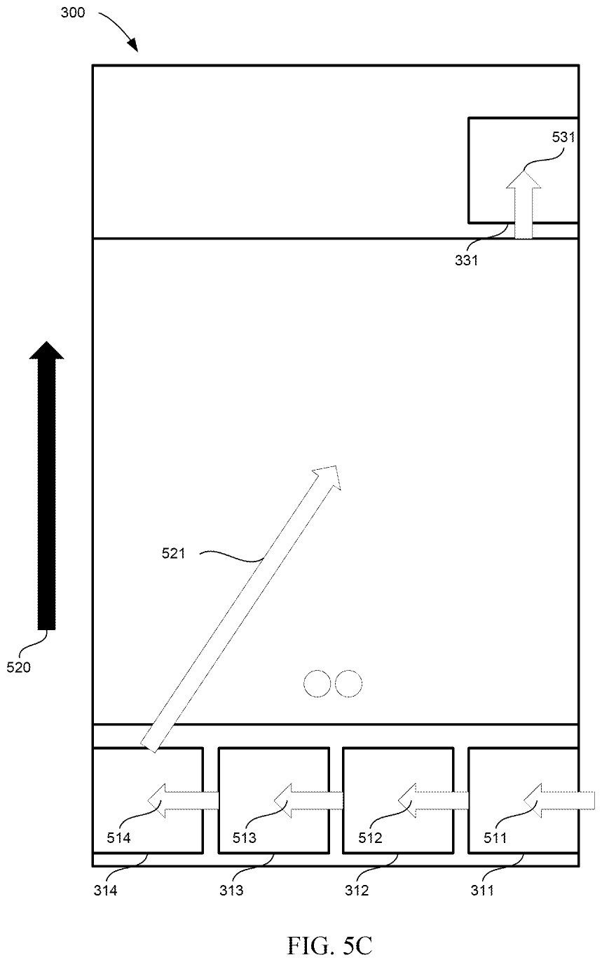

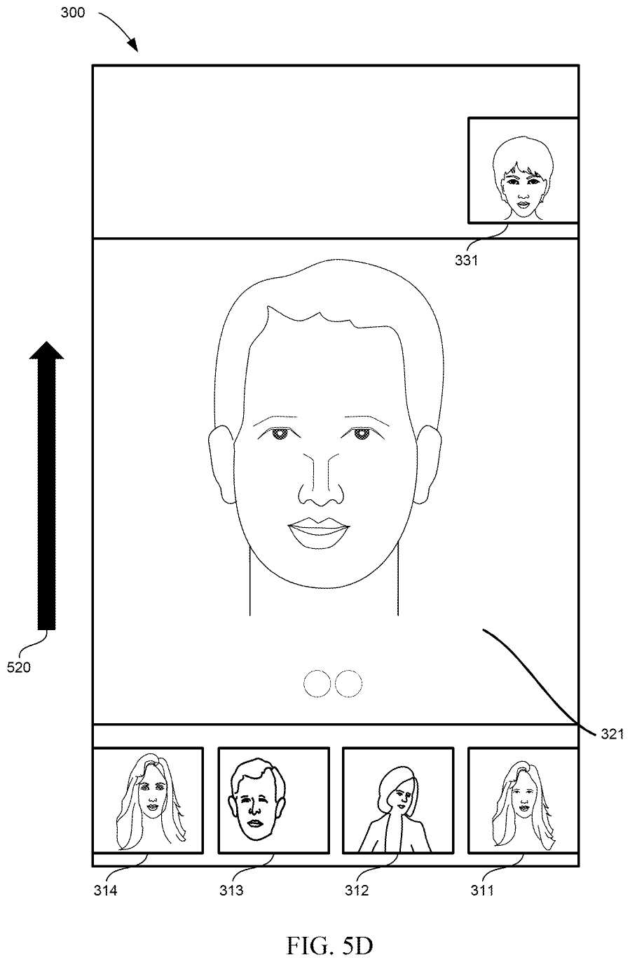

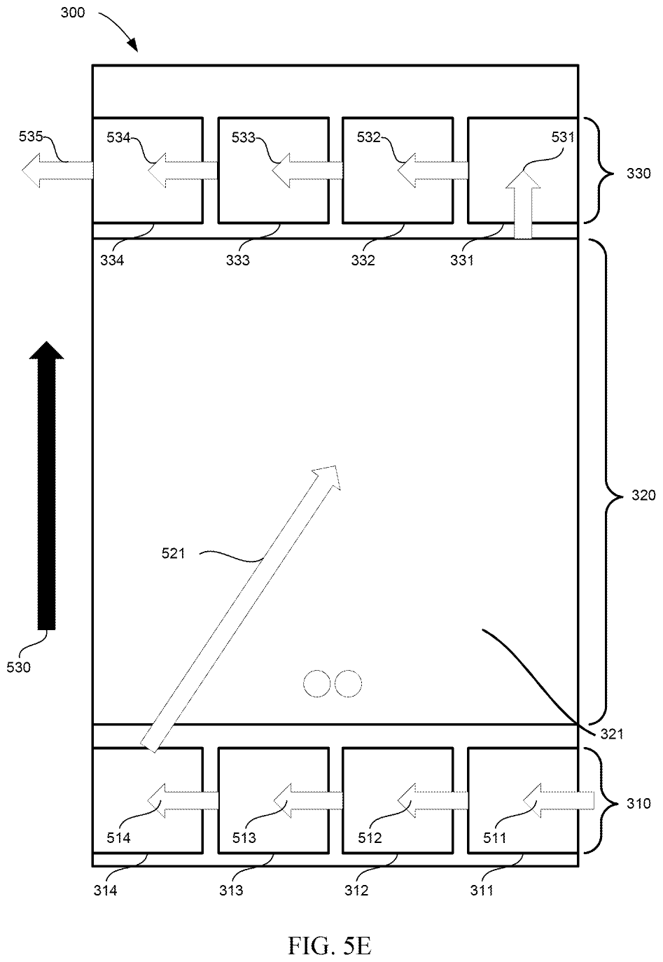

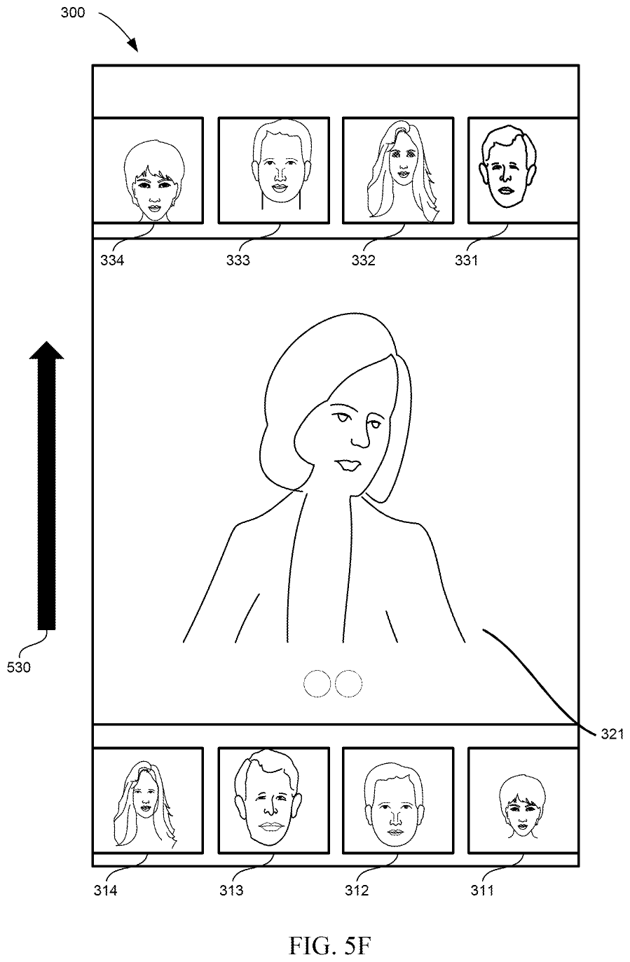

The interface 300 may be configured to move the image chain through the media locations in a snaking pattern, as illustrated in FIGS. 5A-5F. In this regard, upon receiving a user input indicating a request for advancement of the images through the interface, such as an upward swipe on a touch-screen 222 of the user computing device 120, the multimedia data in the interface may move to a next media location. For example, FIG. 5A illustrates a user input, in the form of an upward swipe indicated by arrow 510, requesting advancement of the images being received. Upon receiving the upward swipe, the images may move, in the directions indicated by arrows 511-514 and 521, from the initial position (as shown in FIG. 4). In this regard, the image at media location 311 may move to media location 312, as illustrated by arrow 512. The image at media location 312 may move to media location 313, as illustrated by arrow 513. The image at media location 313 may move to media location 314, as illustrated by arrow 514. The image at media location 314 (i.e., the “lead image”) may move to media location 321, as illustrated by arrow 521. Finally, a new image may be moved into media location 311, as illustrated by arrow 511. In this example, the images at media locations 313, 312, and 311 (prior to the user input) may be considered intervening images.

FIG. 5B illustrates the movement of the images shown in FIG. 4, in response to user input 510 requesting advancement of the images through the interface. As shown, the image previously at media location 314 has moved to media location 321 and a new image has moved into media location 311. The images previously at media locations 311, 312, and 313 have moved into media locations 312, 313, and 314, respectively.

FIG. 5C illustrates the movement of the images within the interface 300 upon receiving a second upward swipe (indicating a request for another advancement of the images), as illustrated by arrow 520. Similar to the movement with respect to a first upward swipe (shown in FIG. 5A,) the images may move in the directions indicated by arrows 511-514 and 521. In addition, the image at media location 321 may move to new media location 331, as illustrated by arrow 531.

FIG. 5D illustrates the movement of the images shown in FIG. 5B, in response to user input 520. As shown, the image previously at media location 314 has moved to media location 321, and a new image has moved into media location 311. Additionally, the image previously at media location 321 has moved to media location 331. The images previously at media locations 311, 312, and 313 have moved into media locations 312, 313, and 314, respectively.

FIG. 5E illustrates the movement of the multimedia within the interface 300 upon receiving a third and subsequent upward swipes (indicating additional advancements), all represented by arrow 530. In this regard, media locations may continue to be added to the upper row with each upward swipe until the upper row is completed, which in this example is when the upper row 330 includes four media locations 331-334. Similar to the movement in response to the second upward swipe (shown in FIG. 5C,) the images may move in the directions indicated by arrows 511-514, 521, and 531. In addition, the image at media location 331 may move to media location 332, as illustrated by arrow 532, the image at media location 332 may move to media location 333, as illustrated by arrow 533, and the image at media location 333 may move to media location 334, as illustrated by arrow 534. When an image is present at media location 334 and an upward swipe is received, the image at media location 334 may move off of the display, as illustrated by arrow 535.

The snaking pattern movement of the image chain through the media locations in interface 300 is fully illustrated in FIG. 5E. In this regard, images generally move into media location 311 first (with the exception of images in different initial positions). The images in media location 311 then progress through the other media locations in the bottom row 310 from right to left. From media location 314, the images may then progress to media location 321 in the center row 320. The images may then progress back to the right side of the interface into media location 331 in the top row 330. The images may then progress to the left side of the top row 330 ending in media location 334. In the event an image is located in media location 331 when another user input advancing the images is received, the image at media location 331 may move off of the interface 300.

FIG. 5F illustrates the movement of the images shown in FIG. 5D, in response to user inputs 530. As shown, the image previously at media location 331 has moved to media location 334, the image previously at media location 321 has moved to media location 333, the image previously at media location 314 has moved to media location 332, the image previously at location 313 has moved to media location 331, the image previously at media location 312 has moved to media location 321, the image previously at media location 311 has moved to media location 314. New images have moved to media locations 313, 312, and 311.

Although FIGS. 5A-5F illustrate the images moving from right to left in the top row 330 and bottom row 310, the images may move from left to right. For instance, images may initially load into media location 314 then progress from left to right ending at media location 311 in the bottom row 310. From there, the images may go to the center row 320 then subsequently to media location 334 in the top row 330. From media location 334, the images may traverse the top row in a left to right fashion ending in media location 331, before being moved off the interface 300 if an additional advancement request is received.

Although FIGS. 5A-5F illustrate the images of the image chain moving through all of the multimedia locations, in some instances, media locations may be sticky, in that the multimedia data displayed in this media location does not move in response to a user input to advance or reverse the multimedia chain. One or more pieces of multimedia data in a multimedia chain may be identified as sticky. Such pieces of sticky multimedia data may be the pieces of data displayed in sticky media locations. For instance, the lead piece of data, the tailpiece of data, and/or any of the intervening pieces of data may be identified as sticky multimedia data. In some instances, sticky multimedia data may be assigned to sticky media locations. In some examples, the sticky multimedia data may be an advertisement. For instance, the top row of the interface may include a single rectangular media location where an advertisement may be shown. The advertisement may change when a user selects a new image chain (as discussed herein).

Sticky multimedia data may be displayed in sticky media locations at initialization and/or once the sticky multimedia data reaches a sticky media location. For instance, and referring to FIG. 5E, media location 334 may be a sticky media location where the lead image of an image chain will be displayed when the image chain is loaded into interface 300. In another example, the lead image may load into a typical starting location, and then “stick” to the sticky media location once a user moves the lead image (or another sticky image) into the sticky media location. Referring to FIG. 5F, the image at media location 334 may stick to this media location. However, in the event another user input to advance the image chain is received, the image at location 334 may remain, and the image at location 333 may move off of the screen. Similarly, any images that move onto the interface in response to a user request to move the image chain in a reverse pattern (described herein) may move to location 333, bypassing location 334.

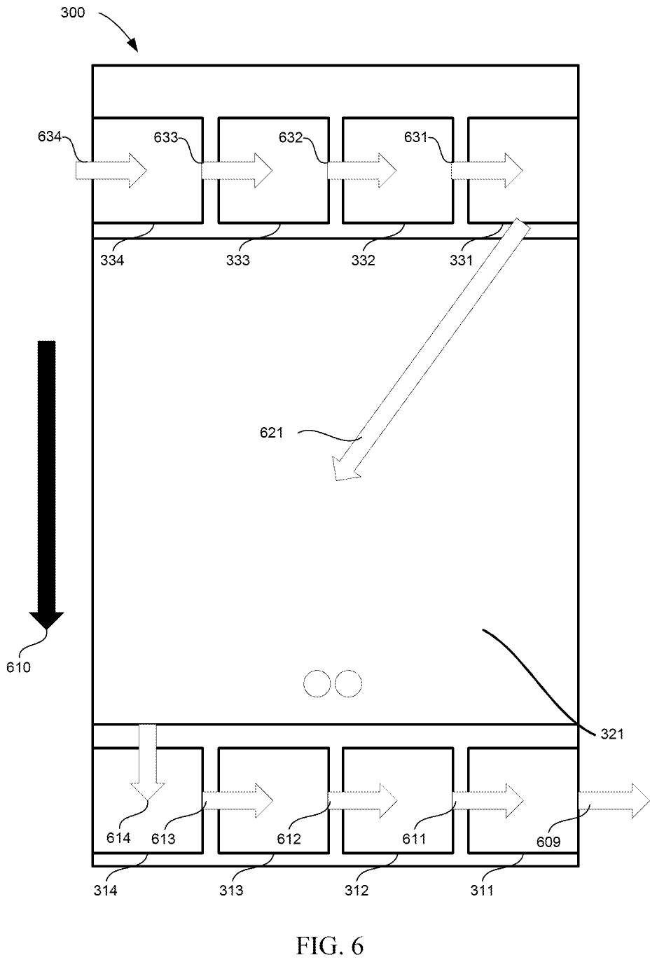

The interface 300 may also be configured to move the image chain through the media locations in a reverse snaking pattern, as illustrated in FIG. 6. In this regard, upon receiving a user input indicating a request for reversal of the images through the interface, such as a downward swipe on a touch-screen 222 of the user computing device 120, the multimedia data in the interface may move to a next media location in a reverse movement compared to the advancement discussed with regard to FIGS. 5A-5F. For example, FIG. 6 illustrates a user input, in the form of a downward swipe indicated by arrow 610, requesting reverse movement of the images. Upon receiving the downward swipe, the images may move in a reverse direction indicated by arrows 634-631, 621, 614-611, and 609. In this regard, the image at media location 334 may move to media location 333, as illustrated by arrow 633. The image at media location 333 may move to media location 332, as illustrated by arrow 632. The image at media location 332 may move to media location 331, as illustrated by arrow 631. The image at media location 331 may move to media location 321, as illustrated by arrow 621. The image at media location 321 may move to media location 314, as illustrated by arrow 614. The image at media location 314 may move to media location 313, as illustrated by arrow 613. The image at media location 313 may move to media location 312, as illustrated by arrow 612. The image at media location 312 may move to media location 311, as illustrated by arrow 611. Finally, the image at media location 311 may move off of interface 300, as illustrated by arrow 609.

As further shown in FIG. 6, images may move onto the interface 300 into media location 334, as illustrated by arrow 634. The images that move onto interface 300 may be those previously moved off of the interface in response to an advancement input, with the last image moving off the interface being the first back onto the interface. That is to say, the images of the image chain maintain their positions relative to each other. For instance, a two images may be moved from media location 334 off of the interface in response to two advancement requests received via user inputs. In particular, and in response to a first advancement request, a first image may move from media location 334 off of the interface and a second image may move from media location 333 to 334. In response to the second advancement requests, the second image may move off of interface 300 from media location 334. Upon receiving a first reverse movement user input request (after the two advancement requests), the second image may move into media location 334 and the first image may remain off of interface 300. Upon receiving a second reverse movement user input request, the second image may move into media location 333 from media location 334 and the first image may move into media location 334.

In instances where no images remain in the image chain, media locations may be removed from interface 300. Alternatively, or additionally, placeholder media locations may be maintained in the interface when no images are located at the media locations. In yet another example, where no images remain in the image chain, a new image chain may be displayed. For example, the lead of one image chain may train the tail image of another image chain. This process may continue indefinitely by cycling through all available image chains or the “chain of image chains” may stop once all image chains have been displayed. Although the aforementioned examples discussed with reference to FIGS. 5A-5F describe user inputs as being upwards or downwards swipes, media chain advancement requests and reversal requests, the interface may be programmed such that other user inputs cause media chain advancements and reversals.

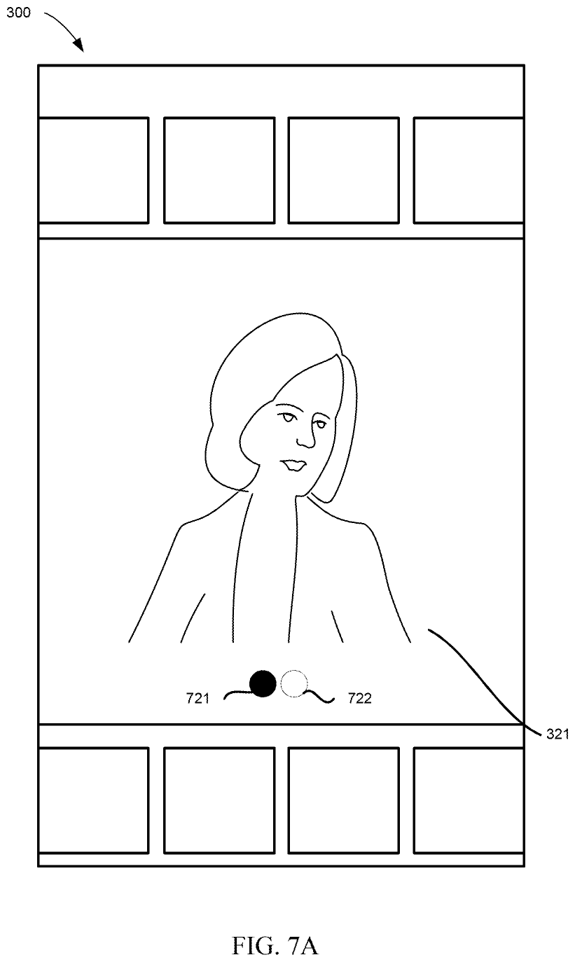

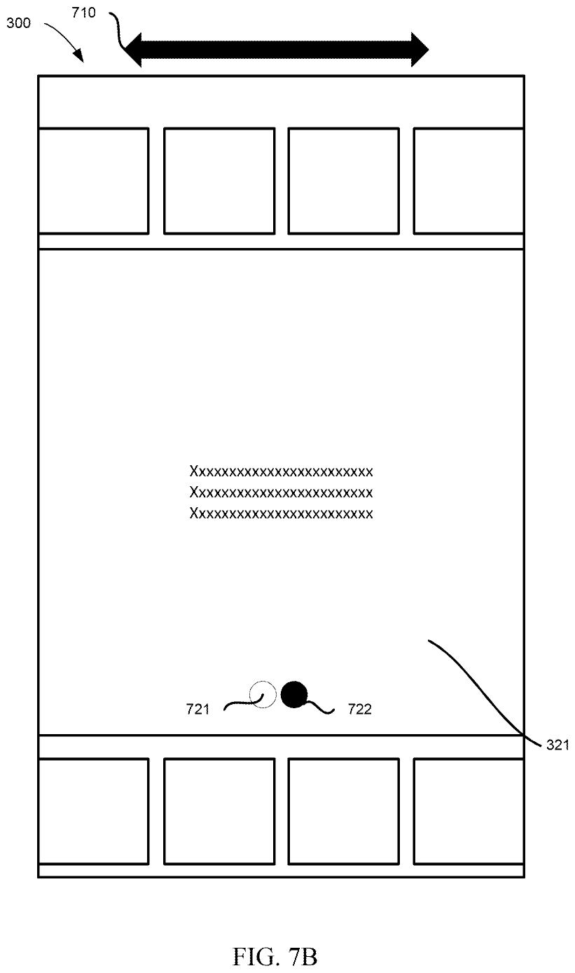

FIGS. 7A and 7B illustrate the ability to provide additional information associated with the multimedia data. In this regard, and as shown in FIG. 7A, an image is located at media location 321. For clarity, other images are not shown in interface 300 in FIGS. 7A and 7B. As shown in FIG. 7B, in response to receiving a user input, such as a sideways swipe, illustrated by arrow 710, the multimedia data (e.g., the image) is replaced with multimedia information corresponding to the multimedia data. Indicators 721 and 722 may be provided to indicate that multimedia information is available for the multimedia data within the media location 321. Referring to FIG. 7A, indicator 721 is highlighted to show that the multimedia data is being displayed, whereas in FIG. 7B indicator 722 is highlighted to show that the multimedia information is being displayed. Although not illustrated, an animation, such as flipping the image over to expose the multimedia information may be shown in the interface 300. Further, although FIGS. 7A and 7B illustrate only media location 321 as being able to display multimedia information, any media location may be programmed to provide multimedia information, with or without indicators. For instance, a user may swipe sideways over a media location to cause the multimedia data to be replaced with multimedia information and vice versa. Further, other user inputs, instead of or in addition to a sideways swipe, may be used to trigger the supply of additional information.

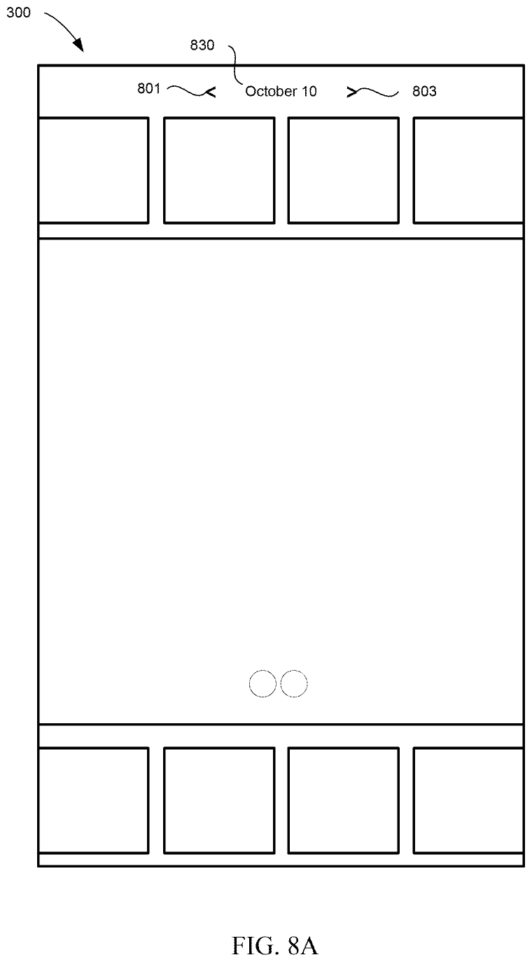

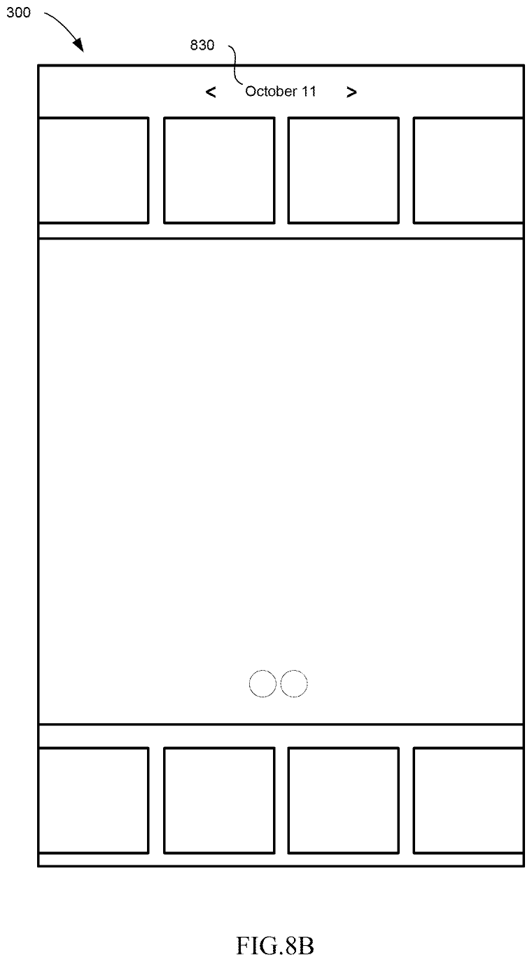

The interface 300 may include a multimedia data set selector. For example, FIG. 8A illustrates set selector icons 801 and 803, along with a set identifier 830, which indicates the currently selected set of multimedia data for display in the interface 300. In this regard, the set identifier 830 indicates that the set of multimedia data selected for display in interface 300 of FIG. 8A is for a set of images associated with October 10. In the event a selector icon is selected, a new set of images may be presented in interface 300. For example, and as illustrated in FIG. 8B, in response to selecting set selector icon 803, a new set of images associated with October 11 may be presented, as identified by set identifier 830.

Although FIGS. 8A and 8B illustrate the set selector icons 801 and 803 as arrows, the set selector icons may be any shape, size, color, etc. In some instances, the interface may not include any set selector icons. Rather, a user may provide an input, such as a double-tap, swipe, etc., to trigger the change of a set of multimedia data.

Unless otherwise stated, the foregoing alternative examples are not mutually exclusive but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including,” and the like, should not be interpreted as limiting the subject matter of the claims to the specific examples; rather, the examples are intended to illustrate only one of many possible embodiments. Further, the same reference numbers in different drawings can identify the same or similar elements.

1. A system for providing an interactive interface, the system comprising:
one or more processors; and
one or more storage devices in communication with the one or more processors, wherein the one or more storage devices contain instructions configured to cause the one or more processors to:
display a set of multimedia data within media locations of an interface, wherein the media locations are positioned across three rows within the interface including a top row, bottom row, and center row and a respective piece of the set of multimedia data is positioned at each media location, wherein the center row includes a single multimedia location;
move, in response to user input requests:
the respective pieces of multimedia data in the media locations in the top row from right to left across the media locations on the top row,
the respective pieces of multimedia data in the media locations in the bottom row from right to left across the media locations on the bottom row, wherein the respective piece of multimedia data in a left-most media location in the bottom row is moved to the single media location in the center row,
the respective piece of multimedia data from the single media location in the center row to a right-most media location in the top row, wherein the media locations remain stationary within the interface during the move; and
provide one or more data selectors configured to change the displayed set of multimedia data within the interface.

2. The system of claim 1, wherein the multimedia data includes one or more of videos, audio, or images.

3. The system of claim 1, wherein the instructions are further configured to cause the one or more processors to change the displayed set of multimedia data with a new set of multimedia data upon receiving a selection of the one or more data selectors.

4. The system of claim 1, wherein the instructions are further configured to cause the one or more processors to display multimedia information in the single media location in the center row upon receiving a second user input request.

5. The system of claim 4, wherein the multimedia information corresponds to the multimedia data at the single media location in the center row.

6. The system of claim 4, wherein the second user input request is a sideswipe on a touch-screen of the system.

7. The system of claim 1, wherein the user input requests are upward swipes on a touch-screen of the system.

8. A non-transitory computer-readable medium storing instructions, which when executed by one or more processors, cause the one or more processors to:
display a set of multimedia data within media locations of an interface, wherein the media locations are positioned across three rows within the interface including a top row, bottom row, and center row and a respective piece of the set of multimedia data is positioned at each media location, wherein the center row includes a single multimedia location;
move, in response to user input requests:
the respective pieces of multimedia data in the media location in the top row from right to left across the media locations on the top row,
the respective pieces of multimedia data in the media locations in the bottom row from right to left across the media locations on the bottom row, wherein the respective piece of multimedia data in a left-most media location in the bottom row is moved to the single media location in the center row, and
the respective piece of multimedia data from the single media location in the center row to a right-most media location in the top row, wherein the media locations remain stationary within the interface during the move; and
provide one or more data selectors configured to change the displayed set of multimedia data within the interface.

9. The non-transitory computer-readable medium of claim 8, wherein the multimedia data includes one or more of videos, audio, or images.

10. The non-transitory computer-readable medium of claim 8, wherein the instructions are further configured to cause the one or more processors to change the displayed set of multimedia data with a new set of multimedia data upon receiving a selection of the one or more data selectors.

11. The non-transitory computer-readable medium of claim 8, wherein the instructions are further configured to cause the one or more processors to display multimedia information in the single media location in the center row upon receiving a second user input request.

12. The non-transitory computer-readable medium of claim 11, wherein the multimedia information corresponds to the multimedia data at the single media location in the center row.

13. A method for interacting with an interface for viewing multimedia data, the method comprising:
displaying, by the one or more computing devices, a subset of multimedia data, selected from a set of multimedia data, at media locations within the interface, each piece of multimedia data within the subset of multimedia data being displayed at a respective media location, wherein the media locations are arranged in three rows including a top row, bottom row, and center row;
receiving, by the one or more computing devices, a user input requesting the subset of multimedia data be advanced within the interface;
moving, in response to the user input and by the one or more computing devices, the subset of multimedia data, said moving including:
moving a first piece of the subset of multimedia data from a media location in the top row off of the interface, and
moving a second piece of the subset of multimedia data from off of the interface into a media location in the bottom row of the interface; and
in response to a second user input, displaying, multimedia information associated with a third piece of the subset of the multimedia data at a media location in the center row.

14. The method of claim 13, wherein the top row includes four media locations, the bottom row includes four media locations, and the center row includes a single media location.

15. The method of claim 14, wherein moving the first piece of the subset of multimedia data from the media location in the top row off of the interface, includes moving the first piece of the subset of multimedia data from a leftmost media location in the top row of the interface.

16. The method of claim 15, wherein moving the second piece of the subset of multimedia data from off of the interface into the media location in the bottom row of the interface includes moving the second piece of the subset of multimedia data into a rightmost media location in the bottom row of the interface.

17. The method of claim 14, wherein the moving further includes moving the third piece of the subset of multimedia data from a leftmost media location in the bottom row to the single media location in the center row.

18. The method of claim 17, further comprising:
receiving a third user input requesting the subset of multimedia data be advanced within the interface; and
moving, in response to the user input, the third piece of the subset of multimedia data from the single media location in the center row to a rightmost media location in the top row.

19. The method of claim 18, wherein the multimedia data includes one or more of videos, audio, or images.

20. The method of claim 13, further comprising:
receiving a third user input requesting a new subset of multimedia data selected from the set of multimedia data; and
replacing the displayed subset of multimedia data with a second subset of multimedia data within the interface.
